(19) United States
(12) Patent Application Publication
(10) Pub. No.: US 2016/0125652 A1
(43) Pub. Date: May 5, 2016

(54) AUGMENTED REALITY SUPERVISOR DISPLAY

(71) Applicant: Avaya Inc., Santa Clara, CA (US)

(72) Inventors: Tony McCormack, Galway (IE); Dawid Nowak, Dublin (IE); Neil O'Connor, Galway (IE)

(21) Appl. No.: 14/530,885

(22) Filed: Nov. 3, 2014

(51) Int. Cl. G06T 19/00; H04N 13/04; G06F 3/01

(52) U.S. Cl. CPC G06T 19/006; G06F 3/013; H04N 13/044

(57) ABSTRACT

Apparatus and method to display worker status for a supervisor, the apparatus including: a frame configured to be coupled to a head of the supervisor; a processor coupled to the frame, the processor configured to render a transparent display of worker status to the supervisor; a position determination module configured to determined a physical location of the frame; a communication module communicatively coupled to the processor and to the position determination module, the communication module configured to wirelessly communicate with a base station; and a gaze detector coupled to the frame and communicatively coupled to the processor, the gaze detector configured to detect a direction of gaze of the supervisor.

### BACKGROUND

1. Field

Embodiments of the present invention generally relate to monitoring contact center agents and performance, and, in particular, to an apparatus and method to monitor by use of augmented reality techniques.

2. Description of Related Art

Within a contact center (CC) of an enterprise, one supervisor usually manages multiple agents. The supervisor usually spends a substantial amount of time monitoring the Key Performance Indicators (KPIs) and other real-time business information, in order to keep the contact center operating within prescribed limits. Some of the main KPIs of the contact center include: quality, customer satisfaction, and average handle time (AHT). Contact centers often have clients who expect a certain target KPIs to be met. The target KPIs are defined as a set of values corresponding to quality, customer satisfaction rating, and average handling time for each call handled by the contact center. In certain scenarios, the supervisors may be required to implement certain operational changes such as increasing or decreasing the KPIs in order to bring the deviating KPIs back within the prescribed limits. However, increasing one KPI component may affect another KPI negatively or often have unintended side effects on the overall performance of the contact center.

For example, a contact center attempting to improve its KPIs may change the assignment of new tasks to agents, or may change the level of oversight over some agents. For example, underperforming agents who are dragging down KPIs may be assigned fewer tasks or may be subject to more oversight by a supervisor. Conversely, an over performing agent may be able to provide some relief to other agents, or may require less oversight by a supervisor.

Traditional systems and methods for monitoring agent performance have involved providing a status display to a communication terminal operated by a supervisor and which is in communication with sensors that measure the various KPIs. The communication terminal has traditionally been either a desktop terminal, or a portable terminal such as a laptop or tablet. Such systems of the known art suffer a disadvantage in that a supervisor may find it difficult to interact simultaneously with the agents being supervised and the KPI reports, i.e., the supervisor cannot interact with the supervised agents in context with KPI reports. For example, a supervisor interacting with an agent may need to divert his attention back and forth between the agent and the KPI reports. Furthermore, the agents most in need of oversight might not be immediately apparent from a plurality of agents being supervised, or some of the agents being supervised may not be physically co-located with other agents or with the supervisor.

Therefore, a need exists to provide a more flexible and less intrusive way for a contact center supervisor to view and interact with their supervised agents in context with KPIs representing business goals and dynamic information driven by live contact center operations.

### BRIEF SUMMARY

In one embodiment, an apparatus to display worker status for a supervisor includes: a frame configured to be coupled to a head of the supervisor; a processor coupled to the frame, the processor configured to render a transparent display of worker status to the supervisor; a position determination module configured to determined a physical location of the frame; a communication module communicatively coupled to the processor and to the position determination module, the communication module configured to wirelessly communicate with a base station; and a gaze detector coupled to the frame and communicatively coupled to the processor, the gaze detector configured to detect a direction of gaze of the supervisor.

In one embodiment, a method to display worker status for a supervisor includes: associating a frame to the supervisor, wherein the frame is configured to be coupled to a head of the supervisor; receiving indicators of workers associated with the supervisor; displaying on a transparent display the indicators of workers associated with the supervisor; detecting a request for more information about an object displayed on the transparent display; receiving detailed information about the object displayed on the transparent display; and displaying the detailed information on the transparent display.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a contact center in accordance with an embodiment of the present invention;

FIG. 2 is block diagram depicting a server in accordance with an embodiment of the present invention;

FIG. 3 is a perspective display of an augmented reality display device in accordance with an embodiment of the present disclosure;

FIG. 4 is a first example of an augmented reality display in accordance with an embodiment of the present disclosure;

FIG. 5 is a second example of an augmented reality display in accordance with an embodiment of the present disclosure; and

FIG. 6 is a process in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in any communication application in which it is desirable to utilize augmented reality techniques.

The exemplary systems and methods of this disclosure will also be described in relation to software, modules, and associated hardware. However, to avoid unnecessarily obscuring the present disclosure, the following description omits well-known structures, components and devices that may be shown in block diagram form, are well known, or are otherwise summarized.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

As used herein in connection with embodiments of the present invention, the term “contact” (as in “customer contact”) refers to a communication from a customer or potential customer, in which a request is presented to a contact center. The request can be by way of any communication medium such as, but not limited to, a telephone call, e-mail, instant message, web chat, and the like.

As used herein in connection with embodiments of the present invention, the term “customer” denotes a party external to the contact center irrespective of whether or not that party is a “customer” in the sense of having a commercial relationship with the contact center or with a business represented by the contact center. “Customer” is thus shorthand, as used in contact center terminology, for the other party to a contact or a communications session.

The terms “switch,” “server,” “contact center server,” or “contact center computer server” as used herein should be understood to include a Private Branch Exchange (“PBX”), an Automated Contact Distribution (“ACD”) system, an enterprise switch, or other type of telecommunications system switch or server, as well as other types of processor-based communication control devices such as, but not limited to, media servers, computers, adjuncts, and the like. The term “server” where used may refer to an individual server or a cluster of servers, unless a different meaning is clearly indicated.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “gateway” may generally comprise any device that sends and receives data between devices. For example, a gateway may comprise routers, switches, bridges, firewalls, other network elements, and the like, any and combination thereof.

As used herein, the term “transmitter” may generally comprise any device, circuit, or apparatus capable of transmitting a signal. As used herein, the term “receiver” may generally comprise any device, circuit, or apparatus capable of receiving a signal. As used herein, the term “transceiver” may generally comprise any device, circuit, or apparatus capable of transmitting and receiving a signal. As used herein, the term “signal” may include one or more of an electrical signal, a radio signal, an optical signal, an acoustic signal, and so forth.

The term “computer-readable medium” as used herein refers to any tangible, non-transitory storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

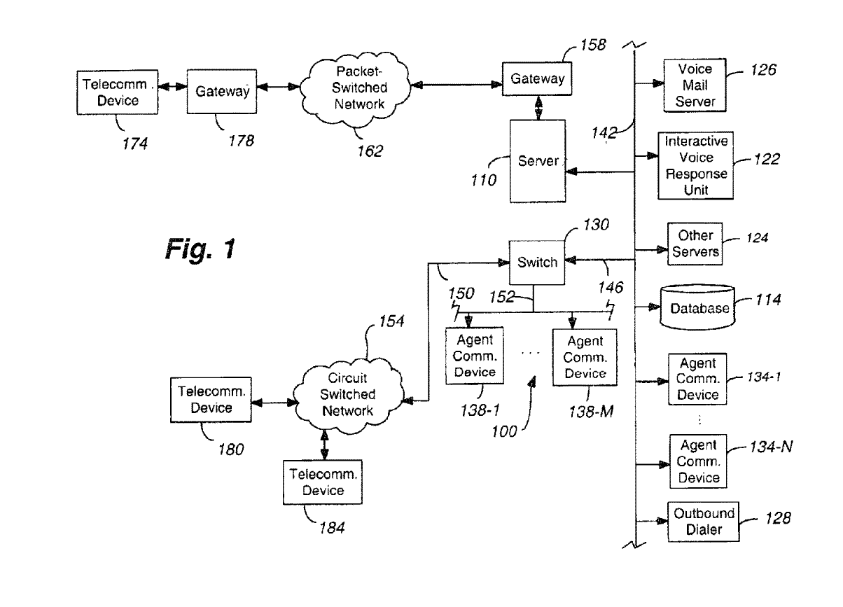

Referring now to FIG. 1, which is a block diagram depicting a contact center 100 in accordance with an embodiment of the present invention. The contact center 100 generally comprises a central server 110, a set of data stores or databases 114 containing contact or customer related information and other information that can enhance the value and efficiency of the contact, and a plurality of servers, for example, a voice mail server 126, an Interactive Voice Response unit or “IVR” 122, and other servers 124, an outbound dialer 128, a switch 130, a plurality of working agents operating packet-switched (first) telecommunication devices 134-1 to N (such as, but not limited to, computer work stations or personal computers), and/or circuit-switched (second) telecommunication devices 138-1 to M, all interconnected by a local area network LAN (or wide area network WAN) 142. The servers can be connected via optional communication lines 146 to the switch 130.

As will be appreciated, the other servers 124 can also include a scanner (which is normally not connected to the switch 130 or Web server), VoIP software, video call software, voice messaging software, an IP voice server, a fax server, a web server, an instant messaging server, and an email server) and the like. The switch 130 is connected via a plurality of trunks 150 to the Public Switch Telecommunication Network or PSTN 154 and via link(s) 152 to the second telecommunication devices 138-1 to M. A gateway 158 is positioned between the server 110 and the packet-switched network 162 to process communications passing between the server 110 and the network 162.

The gateway 158 may comprise Avaya Inc.'s, G250™, G350™, G430™, G450™, G650™, G700™, and IG550™ Media Gateways and may be implemented as hardware such as, but not limited to, via an adjunct processor (as shown) or as a chip in the server.

The first telecommunication devices 134-1, . . . 134-N are packet-switched device, and may include, for example, IP hardphones, such as the Avaya Inc.'s, 1600™, 4600™, and 5600™ Series IP Phones™; IP softphones running on any hardware platform such as PCs, Macs, smartphones, or tablets, (such as Avaya Inc.'s, IP Softphone™); Personal Digital Assistants or PDAs; Personal Computers or PCs, laptops; packet-based H.320 video phones and/or conferencing units; packet-based voice messaging and response units; and packet-based traditional computer telephony adjuncts.

The second telecommunication devices 138-1, . . . 138-M are circuit-switched. Each of the telecommunication devices 138-1, . . . 138-M corresponds to one of a set of internal extensions, for example, Ext1, . . . ExtM, respectively. These extensions are referred to herein as “internal” in that they are extensions within the premises that are directly serviced by the switch. More particularly, these extensions correspond to conventional telecommunication device endpoints serviced by the switch/server, and the switch/server can direct incoming calls to and receive outgoing calls from these extensions in a conventional manner.

The second telecommunication devices can include, for example, wired and wireless telephones, PDAs, H.320 video phones and conferencing units, voice messaging and response units, and traditional computer telephony adjuncts. Exemplary digital telecommunication devices include Avaya Inc.'s 2400™, 5400™, and 9600™ Series phones.

It should be noted that embodiments of the present invention do not require any particular type of information transport medium between switch or server and first and second telecommunication devices, i.e., embodiments of the present invention may be implemented with any desired type of transport medium as well as combinations of different types of transport media.

The packet-switched network 162 of FIG. 1 may comprise any data and/or distributed processing network such as, but not limited to, the Internet. The network 162 typically includes proxies (not shown), registrars (not shown), and routers (not shown) for managing packet flows. The packet-switched network 162 is in (wireless or wired) communication with an external first telecommunication device 174 via a gateway 178, and the circuit-switched network 154 with an external (wired) second telecommunication device 180 and (wireless) third (customer) telecommunication device 184. These telecommunication devices are referred to as “external” in that they are not directly supported as telecommunication device endpoints by the switch or server. The telecommunication devices 174 and 180 are an example of devices more generally referred to herein as “external endpoints.”

In one configuration, the server 110, network 162, and first telecommunication devices 134 are Session Initiation Protocol or SIP compatible and may include interfaces for various other protocols such as, but not limited to, the Lightweight Directory Access Protocol or LDAP, H.248, H.323, Simple Mail Transfer Protocol or SMTP, IMAP4, ISDN, E1/T1, and analog line or trunk.

It should be emphasized the configuration of the switch, server, user telecommunication devices, and other elements as shown in FIG. 1 is for purposes of illustration only and should not be construed as limiting embodiments of the present invention to any particular arrangement of elements.

In handling incoming calls, contact center 100 is capable of exchanging Internet Protocol (IP) data packets, Session Initiation Protocol (SIP) messages, Voice over IP (VoIP) traffic, and stream-related messages (e.g., Real Time Streaming Protocol [RTSP] messages, etc.) with external endpoints 174. As those who are skilled in the art will appreciate, after reading this specification, contact center 100 is capable of communicating by using other protocols, in some alternative embodiments.

As will be appreciated, the central server 110 is notified via LAN 142 of an incoming contact by the telecommunications component (e.g., switch 130, fax server, email server, web server, and/or other server) receiving the incoming contact. The incoming contact is held by the receiving telecommunications component until the server 110 forwards instructions to the component to route, and then forward the contact to a specific contact center resource such as, but not limited to, the IVR unit 122, the voice mail server 126, the instant messaging server, and/or first or second telecommunication device 134, 138 associated with a selected agent. The server 110 distributes and connects these contacts to telecommunication devices of available agents, based on the predetermined criteria noted above.

When the central server 110 forwards a voice contact to an agent, the central server 110 also forwards customer-related information from databases 114 to the agent's computer work station for viewing (such as by a pop-up display) to permit the agent to better serve the customer. The agents process the contacts sent to them by the central server 110. This embodiment is particularly suited for a Customer Relationship Management (CRM) environment in which customers are permitted to use any media to contact a business. In the CRM environment, both real-time and non-real-time contacts may be handled and distributed with equal efficiency and effectiveness. The server 110 may use a work assignment algorithm that, for example, does not use a queue. In any event, the contact may have associated or “known” contact information. This contact information may include, for example, how long the contact has been waiting, the contact's priority, the contact's media channel, the contact's business value, etc. The contact may be handled based on such known contact information.

The server and/or switch can be a software-controlled system including a processing unit (CPU), microprocessor, or other type of digital data processor executing software or an Application-Specific Integrated Circuit (ASIC) as well as various portions or combinations of such elements. The memory may comprise random access memory (RAM), a read-only memory (ROM), or combinations of these and other types of electronic memory devices. Embodiments of the present invention may be implemented as software, hardware (such as, but not limited to, a logic circuit), or a combination thereof.

The contact center 100, in one configuration, includes an automated instant messaging server as another server 124. In such an embodiment, when a customer initiates contact with the contact center 100 using instant messaging, a new instant messaging thread is initiated by the customer. As will be appreciated, instant messages are stand-alone messages, and threading (or associating instant messages with data structures associated with an instant messaging session between a customer and an agent) occurs at the application level. The association is typically effected by pairing an electronic address (e.g., IP address, Media Access Control (MAC) address, telephone number, mobile-device identifier, and the like) of the customer's communication device with an electronic address (e.g., IP address, MAC address, telephone number, mobile-device identifier, and the like) of the agent's communication device in a manner similar to that used for a voice call.

The instant messaging server can be configured to send an automated response, such as “Please wait while I connect you with an agent” and/or to send the instant message to an automated interactive response unit for data collection. The instant messaging server subsequently notifies the server 110 of the existence of a new instant messaging contact, and the server 110 decides whether a suitable (human) agent is available. If an agent is available, the server 110 instructs the instant messaging server to redirect the instant messaging conversation to that available agent's communication device 134-1 . . . N. The server 110 routes, substantially in real-time, subsequent instant messages from the agent's communication device to the customer's communication device and from the customer's communication device to the agent's communication device.

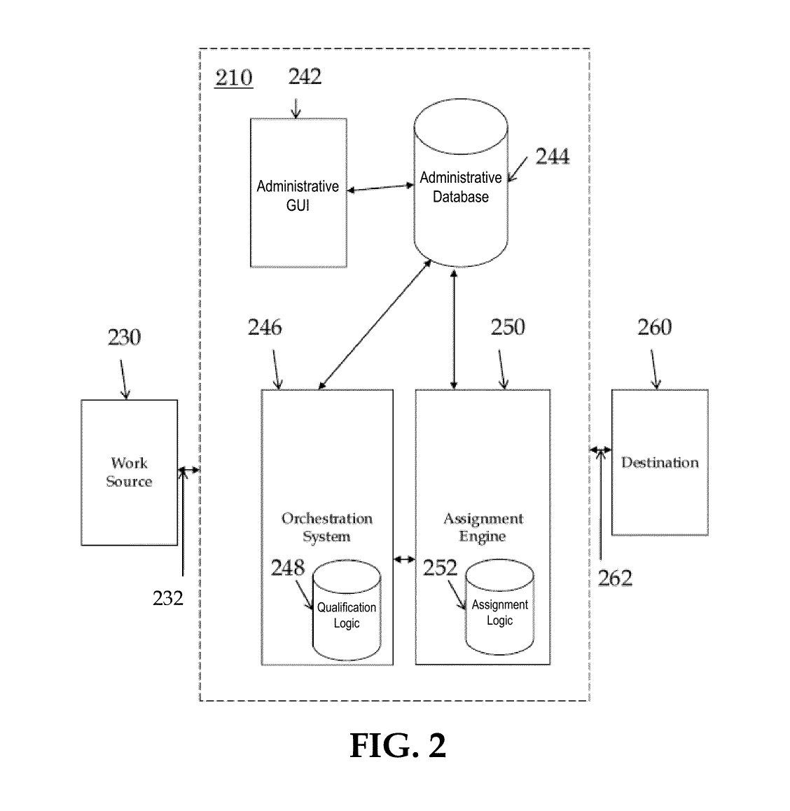

Referring to FIG. 2, which depicts a block diagram of a server 210 in accordance with an embodiment of the present invention. Server 210 is illustrated in communication with a work source 230, which may comprise customer or any other entity capable of originating a transmission of work or a contact. The server 210 may be configured in communication with the work source 230 generally via a work source communication link 232, which may comprise any means of communicating data, for example, one or more trunks, phone lines, wireless connections, Bluetooth connections, digital connections, analog connection, combinations thereof, and the like.

In some embodiments of the present invention, the server 210 may also be in communication with a destination 260, which may comprise an agent or any entity capable of receiving a transmission of work or a contact. The server 210 may be configured in communication with the destination 260 generally via an agent communication means 262, which may comprise substantially any type of communication link, for example, a voice-and-data transmission line such as LAN and/or a circuit switched voice line, wireless connections, Bluetooth connections, digital connections, analog connections, combinations thereof, and the like. The server 210 may comprise any type of computer server, for example, a Basic Call Management System (“BCMS”) and a Call Management System (“CMS”) capable of segmenting work.

The server 210 can be any architecture for directing contacts to one or more telecommunication devices. Illustratively, the server may be a modified in the form of Avaya Inc.'s Private-Branch Exchange (PBX)-based ACD system; MultiVantage™ PBX, CRM Central 2000 Server™, Communication Manager™, Business Advocate™, Call Center™, Contact Center Express™, Interaction Center™, and/or S8300™, S8400™, S8500™, and S8700™ servers; or Nortel's Business Communications Manager Intelligent Contact Center™, Contact Center—Express™, Contact Center Manager Server™, Contact Center Portfolio™, and Messaging 100/150 Basic Contact Center™.

In many embodiments, the server 210 may be a stored-program-controlled system that conventionally includes, for example, interfaces to external communication links, a communications switching fabric, service circuits (e.g., tone generators, announcement circuits, and the like), memory for storing control programs and data, and a processor (i.e., a computer) for executing the stored control programs to control the interfaces and the fabric and to provide automatic contact-distribution functionality. The server 210 generally may include a network interface card (not shown) to provide services to the serviced telecommunication devices.

The server 210 may be configured for segmenting work in the contact center and may comprise an administrative database 244 configured to store at least a common skill option and a service skill option; an administrative graphical user interface (“GUI”) 242 for accessing at least the administrative database 244 and configuring the common skill option and the service skill option; an orchestration system 246 configured to receive a contact from a work source 230 and orchestrate the contact according to a qualification logic stored in a qualification logic database 248; and an assignment engine 250 configured to receive the contact, the common skill option, and the service skill option, and segment the contact according to an assignment logic stored in an assignment logic database 252. In accordance with some embodiments of the present invention, the qualification logic stored in the qualification logic database 248 and the assignment logic stored in the assignment logic database 252 may comprise any logical set of steps or sequences configured to process data at the contact center in accordance with any embodiment of the present invention.

The server and/or switch can be a software-controlled system including a processing unit (CPU), microprocessor, or other type of digital data processor executing software or an Application-Specific Integrated Circuit (ASIC) as well as various portions or combinations of such elements.

Automatic Call Distribution (“ACD”) is a communication server software feature that processes incoming, outgoing, and internal calls and distributes them to groups of extensions called hunt groups or splits. The communication server also sends information about the operation of the ACD to the Call Management System (“CMS”) which stores and formats the data and produces real-time and historical reports on ACD activity. ACD is used by a contact center to route incoming calls to specifically assigned splits/skills and agents. ACD allows a system administrator to create an efficient call management environment.

System 100 of FIG. 1 may be used to support embodiments described herein. For example, users of a client running on one or more communication terminals 112 may be communicatively connected via network 108 to a server such a server 110. Various logs related to client operation (e.g., memory or CPU utilization, hardware or software versions, communication link usage, etc.) may be stored in memory.

Embodiments in accordance with the present disclosure provide a personal augmented reality (AR) display device and methods for using the same. For ease of reference, the personal augmented reality display device may be referred to as simply the AR display device. The AR display device is personal because ordinarily only the wearer perceives images produced by the AR display device. Several different physical configurations may be used for the AR display device. For example, the AR display device may be provided as a headset that provides a display in the wearer's field of view and is removably affixed to the wearer's head, e.g., by covering a substantial portion of the head like a cap or helmet, or by being removably affixed to a wearer's ear by use of a boom running between the ear and the wearer's field of view, and so forth. Alternatively, the AR display device may be provided as goggles, which could fit over a person's prescription glasses. Alternatively, the AR display device may be worn as a frame like conventional sunglasses or prescription glasses. The frame may be provided with or without lenses.

Alternatively, the AR display may be provided as a retinal image. Alternatively, the hardware of the AR display device may be based in part upon a commercial product such as Google Glass™, but customized to provide the embodiments described herein.

An aspect of the AR display device is that the person wearing the AR display device may still visually perceive a physical view of his actual surroundings, for instance by providing the AR display device as a substantially transparent display, much like a heads-up display, without requiring users to look away from their physical view when perceiving the content of the AR display device. A user's fovea may be focused on the AR display, while the user's peripheral vision can perceive the physical view, which may be many feet or yards away in the case of a room where supervised agents may be working. In contrast, a virtual reality (VR) display device entirely and immersively replaces a user's physical view with the content of the VR display device, such that the user can no longer visually perceive his actual surroundings.

The display provided by the AR display device includes information related to agents (i.e., employees or workers) under supervision of the supervisor. The paradigm of agents under supervision of the supervisor also applies to the paradigm of employees under supervision of an employer. The AR display device may be associated with a specific supervisor by way of a sign-in procedure on the device itself (e.g., by entering an ID code such as a PIN code), or by using a separate terminal (e.g., a desktop terminal to enter an ID code for a specific AR display device) in order to associate a particular AR display device to a specific supervisor. For example, after an ID code is entered, the ID code may be transmitted to a server such as server 110. The server may be queried to determine which agents are currently under the supervision of the supervisor associated with the ID code. A location of the AR display device may be determined, for example, a larger scope providing geographic location by way of GPS methods, or a smaller scope by use of short-range indoor proximity system (e.g., iBeacon™) and so forth. Both the larger scope and the smaller scope may be referred to herein as positional information.

A display may be rendered on the AR display device based upon the location and/or supervisor identity. The content of the display may include information related to at least some of the agents under the supervision of the supervisor. In some embodiments, the agent information included in the display includes information about only those agents in the immediate vicinity of the supervisor (e.g., within visual sight range, within unaided audible range, within the same room, within a predetermined distance, etc.) who are being supervised by the supervisor. In other embodiments, the agent information included in the display includes information about all agents being supervised by the supervisor, including those agents who are remotely located (e.g., working off-site or otherwise beyond visual sight range and beyond unaided audible range, etc.). In some embodiments, agents in the physical view who are not being supervised by the supervisor (e.g., agents who are being supervised by a different supervisor) may be represented in the display with a lesser amount of information, e.g., only a name, or outline, or avatar, or supervisor's name, etc.

The information related to agents displayed on the AR display device may further include KPI data or statistics (collectively, “KPI data”) related to agents actively under supervision by the supervisor. Arrangement of information may be determined by the physical view, or may be sorted by aspects of the KPI data. For example, if a supervisor is physically in a room with at least some of his supervised agents, the AR display device may display to the supervisor a representation of agents also in the room, along with information about the agents (e.g., identification of such agents, their current performance statistics such as average call handling time, etc.) and/or KPI data (e.g., data applicable to each such agent or the contact center as a whole). In other embodiments, the presented information may include information about agents not physically in the room with the supervisor, e.g., information about all agents being supervised by the supervisor including agents working remotely.

The presentation of the displayed information may indicate a predetermined setting (e.g., a preference set by the supervisor), or may indicate an importance of the information. For example, information about underperforming agents or KPI data who are not currently within acceptable limits is relatively important information, and may be displayed with increased prominence. Increased prominence may be achieved by arrangement (e.g., placing certain items in the forefront or moving other items to the background), bold, italic, font choice, size, color, markers (e.g., arrow, asterisk, etc.), blinking or other time-varying effects, and so forth. Lesser prominence may be marked by moving an item to the background, an absence of the characteristics of increased prominence (e.g., no bolding, no arrow, no blinking, etc.), or by representing the less prominent agent or datum as a small avatar. In general, greater criticality of the underperformance or greater magnitude of underperformance will result in greater prominence of the display.

The AR display device may include a gaze detector, which dynamically detects a direction that a wearer is gazing at, and therefore infers what the wearer is concentrating on at the present time. If an object is within a predetermined gaze region, an inference may be made that the wearer is gazing at the object. The gaze region may be determined by distance (e.g., within an angular limit from) or boundary (e.g., within a box around) the gaze direction. The inference (or a statistical confidence of the inference) of what object the user is concentrating on may depend upon how long the user gazes in a particular direction, and/or how close the object is to the gaze direction. If the gaze direction includes both an item in the AR display and something in the physical view, the inference may give preference to the item in the AR display.

If the gaze detector detects that the wearer is gazing at an item in the AR display (e.g., a representation of an agent being supervised by the supervisor), the AR display device may display additional information about the item being gazed at. The additional information may include more detailed agent-specific performance metrics, contextual information about the agent and/or the communication session the agent is currently handling (e.g., who the customer is and other customer-specific information), more detailed KPI data, previous communications (e.g., textual or media stream) with an agent, a current communication with the agent, a request for communication with the agent, and so forth.

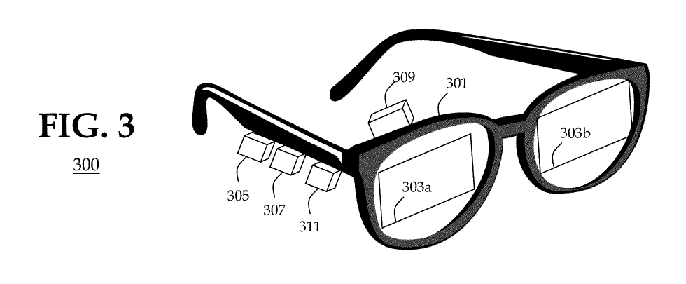

FIG. 3 illustrates an AR display device 300 in accordance with an embodiment of the present disclosure. Device 300 may include a frame 301 that a wearer wears on their head. One or more modules 305, 307, 309 and 311 may be coupled to frame 301. The depiction in FIG. 3 of this coupling is exemplary, and other physical configurations may be used, including the incorporation of such modules within frame 301, or modules may be combined. For example, device 300 may include a communication module 305 to communicate between AR display device 300 and a contact center, e.g., at least to communicate information about KPIs and agents under supervision. Communication module 305 typically includes a transceiver in order to provide wireless two-way communications between device 300 and a base station such as a Wi-Fi base station or a 4G cell tower base station.

Device 300 may further include a position determination module 307 that receives wireless positioning signals, e.g., a GPS receiver, a short-range indoor proximity transponder, and so forth. Position determination module 307 may also be configured to detect and report a positional orientation of device 300, e.g., an orientation with respect to a known frame of reference, such as known points within a room, or with respect to azimuth and elevation angles, or with respect to the north direction, and so forth. Positional orientation may be determined by a sensor such as a force sensor that detects the force of gravity with respect to a predetermined axis of the sensor. Other sensors may also be used instead of or in addition to a force sensor, such as a level, a compass, and so forth.

Device 300 may further include a gaze detector 309 that is configured to detect the direction of a user's gaze and how long the user has been gazing.

Device 300 may further include a processing module 311 (with memory) that is configured to render an AR display 303a and/or 303b based upon at least agent status as received through communication module 305 and gaze detector 309. In some embodiments, separate AR displays 303a and 303b may be provided to each eye in order to provide a stereoscopic view. A stereoscopic view allows for a simulated three-dimensional (3-D) display to be presented to the supervisor. With a 3-D display, prominence of a displayed item may be increased by bringing the item to the forefront, and prominence of a displayed item may be reduced by moving the item to the background. This is unlike the display of conventional two-dimensional (2-D) graphical and textual computer-based information using a device such as Google Glass because such 2-D information is not convertible to a 3-D display, and information such as textual information is not amenable to 3-D presentation, and conventional devices such as Google Glass cannot provide a 3-D display because they provide an image to only one eye. Although VR may provide a 3-D display, they do not show the physical world behind a transparent display. For ease of reference, AR displays 303a and 303b may be referred to collectively as AR display 303, or may be referred to individually as AR display 303 if only one such display is provided or if no distinction is intended between a left and a right side. In some embodiments, AR display 303 may be provided as a retinal image.

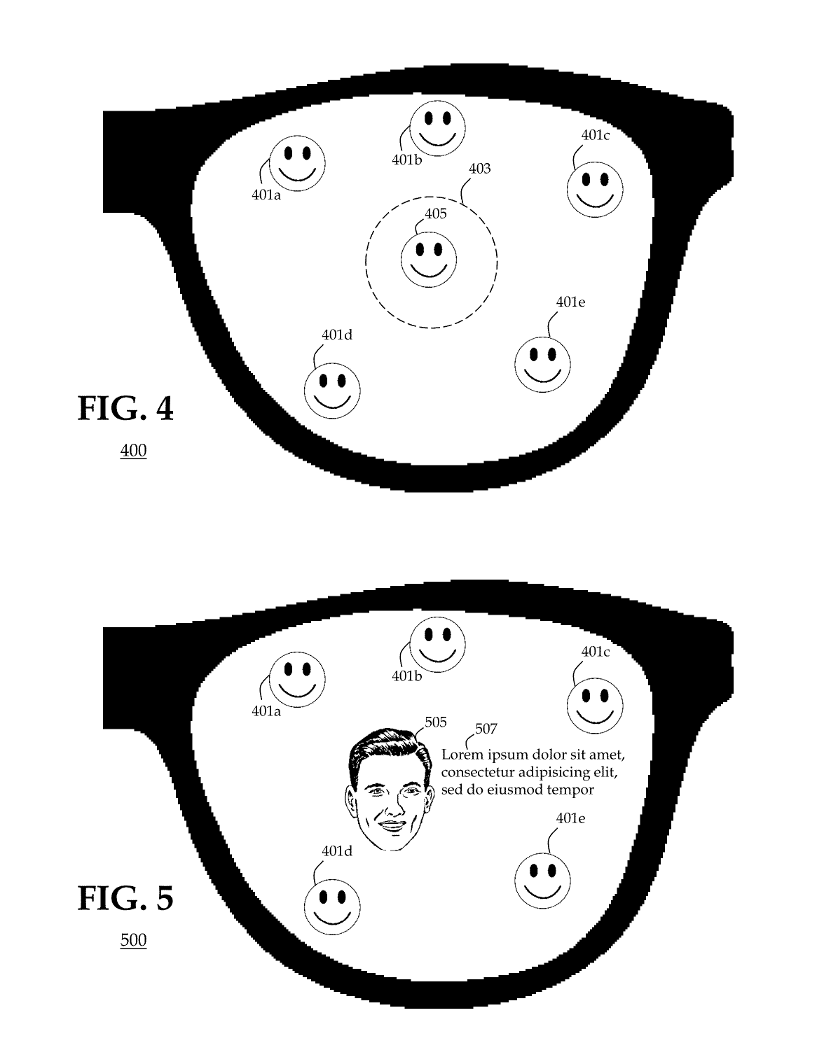

FIG. 4 illustrates an exemplary AR display 400 as may be provided by AR display device 300. AR display 400 may include a plurality of indicators (e.g., avatars) 401a, 401b, 401c, 401d and 401e (collectively, indicators 401) of respective agents under the supervision of the supervisor who are not currently being highlighted. Illustrated on AR display 400 is the boundary 403 of a user gaze region. Boundary 403 or the associated gaze region is not necessarily displayed on AR display 400. Within the gaze region is indicator 405 of another agent whom the supervisor has just begun to gaze upon, but not long enough to trigger the display of more detailed information.

FIG. 5 illustrates an exemplary AR display 500 as may be provided by AR display device 300, but at a later time than AR display 400 of FIG. 4. Elements of like reference numbers have already been described in the context of FIG. 4. Compared to FIG. 4, AR display 500 depicts a display presented to a supervisor after the supervisor has gazed sufficiently long at indicator 405 to trigger the display with high prominence of more detailed information about the agent associated with indicator 405. For example, the more detailed information may include graphical information 505 about the agent (e.g., a photo, a graphical presentation of performance metrics, etc.), or may include textual information 507 (e.g., listing of agent skills, etc.).

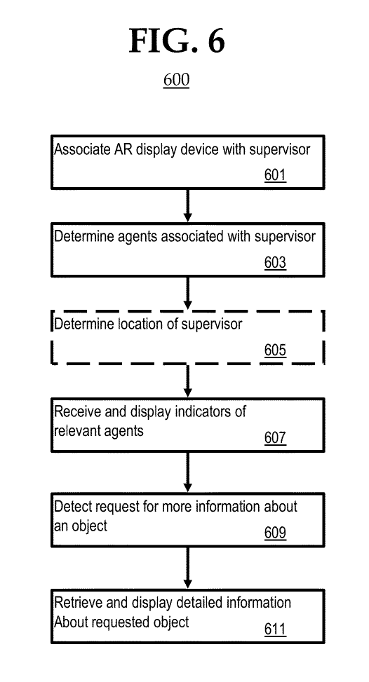

FIG. 6 illustrates a process 600 of operating AR display device 300, in accordance with an embodiment of the present disclosure. Process 600 begins at step 601, at which an AR display device is associated with a supervisor. The association may be entered, e.g., by way of a code entered through AR display device 300 itself such as a PIN code or a code detected and entered through gaze detection. Alternatively, the association may be entered at a second terminal such as a supervisor's tablet or desktop terminal, or the terminal of a system administrator prior to issuing the display device 300 to a supervisor.

Next, process 600 continues to step 603, at which the supervised agents who are associated with the supervisor are determined. The determination may involve querying a server in the contact center to recall information from a database, the information including identification of agents being supervised by the supervisor. The information may include the current work locations of the respective agents.

Next, process 600 continues to optional step 605, at which the supervisor's positional information is determined, e.g., by usage of signals received via position determination module 307, e.g., GPS signals or signals from a short-range indoor proximity transponder, and so forth. Optional step 605 may be skipped if the supervisor wants to view information about agents under their supervision without regard to the positional information of the supervisor, the current work locations of the agents, and/or the closeness of the supervisor to the supervised agents.

Next, process 600 continues to step 607, at which indicators of relevant agents are displayed to the supervisor. Indicators may include brief indicators such as indicators 401 if information about an agent is being displayed with low prominence, or more extensive indicators such as graphical information 505 and/or textual information 507 if agent is being displayed with high prominence.

Next, process 600 continues to step 609, at which AR display device 300 may detect a request for more information about an object. For example, the request may be by way of a gaze detector detecting that the supervisor has gazed at an object (or within a predetermined tolerance from the object) for at least a threshold amount of time, or if the supervisor performs an overt action such as a button press or other physical act (e.g., eye blink).

Next, process 600 continues to step 611, at which detailed information about the requested object is retrieved and displayed to the supervisor. Typically, the retrieval will involve a query by a server in the contact center to a database coupled to the server. The retrieved information may be received by communication module 305 and may be formatted for display by processing module 311. The display will incorporate the appropriate prominences for each agent whose information is being displayed.

By use of the apparatus, system and method described above, a contextually-aware display is provided to a supervisor in a call center environment. The contextually-aware display is achieved through the integration of call center management information with wearable devices, and contextual information retrieved by use of a detected location of the supervisor.

Embodiments of the present invention include a system having one or more processing units coupled to one or more memories. The one or more memories may be configured to store software that, when executed by the one or more processing unit, allows practice of the embodiments, at least by use of processes described herein, including at least in FIG. 6, and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. An apparatus to display worker status for a supervisor, comprising:
a frame configured to be coupled to a head of the supervisor;
a processor coupled to the frame, the processor configured to render a transparent display of worker status to the supervisor;
a position determination module configured to determined a physical location of the frame;
a communication module communicatively coupled to the processor and to the position determination module, the communication module configured to wirelessly communicate with a base station; and
a gaze detector coupled to the frame and communicatively coupled to the processor, the gaze detector configured to detect a direction of gaze of the supervisor.

2. The apparatus of claim 1, wherein the transparent display comprises a separate display for each eye of the supervisor.

3. The apparatus of claim 2, wherein the transparent display provides a three-dimensional image to the supervisor.

4. The apparatus of claim 1, wherein the transparent display is configured to permit a visual perception of a physical surrounding behind the transparent display.

5. The apparatus of claim 1, wherein the transparent display is configured to provide a visual status of a contact center performance metric.

6. The apparatus of claim 1, wherein the transparent display is configured to provide a display of information related to all workers under supervision of the supervisor.

7. The apparatus of claim 1, wherein the transparent display is configured to provide a display of information related to workers under supervision of the supervisor and within an immediate vicinity of the supervisor.

8. The apparatus of claim 1, wherein the processor provides an indication of a prominence with which to display information on the transparent display.

9. The apparatus of claim 1, further comprising: an apparatus to facilitate the provision of an association between the supervisor and the apparatus to display worker status.

10. The apparatus of claim 1, further comprising an orientation module configured to provide a positional orientation with respect to a known frame of reference.

11. The apparatus of claim 1, wherein the position determination module comprises a sort-range indoor proximity transponder.

12. The apparatus of claim 1, wherein the gaze detector is configured to permit the supervisor to make a selection by use of gaze.

13. The apparatus of claim 1, wherein the gaze detector is configured to operate within a predetermined gaze region.

14. The apparatus of claim 13, wherein the gaze detector is configured to give preference to an object on the transparent display within the gaze region over an object in a physical view within the gaze region.

15. The apparatus of claim 12, wherein the processor is configured to provide additional information to the transparent display for an item selected by gaze.

16. An method to display worker status for a supervisor, comprising:
associating a frame to the supervisor, wherein the frame is configured to be coupled to a head of the supervisor;
receiving indicators of workers associated with the supervisor;
displaying on a transparent display the indicators of workers associated with the supervisor;
detecting a request for more information about an object displayed on the transparent display;
receiving detailed information about the object displayed on the transparent display; and
displaying the detailed information on the transparent display.

17. The method of claim 16, further comprising:
determining a location of the supervisor;
displaying on a transparent display indicators of workers within an immediate vicinity of the supervisor;

18. The method of claim 16, wherein the transparent display comprises a three-dimensional display.

19. The method of claim 16, wherein the transparent display is configured to permit a visual perception of a physical surrounding behind the transparent display.

20. The method of claim 16, further comprising a step of displaying a visual status of a contact center performance metric.
